(19) United States
(12) Patent Application Publication
(10) Pub. No.: US 2021/0086221 A1
(43) Pub. Date: Mar. 25, 2021

(54) SLOT-DIE COATING APPARATUS AND SLOT-DIE COATING METHOD

(71) Applicant: Nederlandse Organisatie voor toegepast-natuurwetenschappelijk onderzoek TNO, 's-Gravenhage (NL)

(72) Inventors: Ike Gerke de Vries, Kaatsheuvel (NL); Wihelm Albert Groen, Eindhoven (NL)

(21) Appl. No.: 16/498,928

(22) PCT Filed: Mar. 28, 2018
(86) PCT No.: PCT/NL2018/050188

§ 371 Date: Sep. 27, 2019

(30) Foreign Application Priority Data
Mar. 29, 2017 (EP) 17163635.0

(51) Int. Cl. B05C 11/10; B05D 1/26; B05C 5/00; B05C 5/02

(52) U.S. Cl. CPC B05C 11/1034; B05D 1/265; B05C 5/004; B05C 11/1015; B05C 5/0254; B05C 5/0275; B05C 5/0208

(57) ABSTRACT

A slot-die coating apparatus for manufacturing a patterned coating layer (3) on a substrate surface (1s) of a substrate (1) comprises a slot-die coating head (2), a controlled coating fluid supply system (7) and a substrate carrier (6) for carrying the substrate (1). The slot-die coating head (2) comprises an inlet (21) for receiving coating fluid from the coating fluid supply system and a slit-shaped outflow opening (22) that is communicatively coupled to the inlet and has a slit direction. The controlled coating fluid supply system (7) alternately operates in a first mode (M1) to provide for a flow of coating fluid out of the slit-shaped outflow opening (22) for deposition on the substrate surface and in a second mode (M2) wherein a deposition of coating fluid out of the slit-shaped outflow opening (22) on the substrate surface is interrupted (21). The coating head (2) has an internal coating fluid trajectory extending from the inlet (21) to the slit-shaped outflow opening (22). In a stream-downwards order, the coating fluid trajectory comprises a lateral distribution portion (23) to distribute a flow of fluid over said slit direction, a collection channel (24) extending transverse to the stream-downwards direction, and a flow resistive output portion (25). Upon a transition from the first mode (M1) to the second mode (M2) the coating fluid supply system (7) sucks coating fluid from at least one outlet (26) of the slot-die coating head (2) that is communicatively coupled to the collection channel (24).

### BACKGROUND OF THE INVENTION

### Field of the invention

The present invention pertains to a slot-the coating apparatus.

The present invention further pertains to a slot-die coating method.

### Related Art

Organic coatings layers are typically applied to a substrate as a liquid solution, e.g. for manufacturing OLED or PV devices. For many applications, e.g. manufacturing of photo-active layers and/or light-emitting layers, it may be desired to provide one or more homogeneous coating layers on a substrate, i.e. having a homogeneous layer thickness. One technique for manufacturing a homogeneous coating layer may be referred to as “slot-the coating”. This technique typically comprises providing a slot-the coating head arranged over a substrate surface. The slot-die coating head comprising an outflow opening forming a slit that is arranged in a slit direction over the substrate surface. A coating fluid, e.g. supplied by a coating fluid supply, flows through the outflow opening onto the substrate surface. A relative movement between the outflow opening and the substrate surface is controlled along a coating direction. The coating direction is typically transverse, i.e. having a perpendicular component, to the slit direction. In this way a homogeneous layer may be manufactured along a width of the slit onto the substrate surface.

In addition to having a homogeneous coating layer, it may be desired to provide a patterning of the coating on the substrate surface, e.g. wherein the patterned coating comprises coated areas on the substrate surface separated by uncoated areas. For example, for the manufacture of photo-active layers and/or light-emitting layers it may be desired to provide separated active areas on a substrate, e.g. for building an array of photo-cells.

From JP2009028605 a slot-the coating apparatus is known that provides for an intermittent transfer coating fluid from the slot-the coating head onto the substrate surface. To that end the coating apparatus the slot-die coating head has a manifold with an inlet coupled to a liquid feed pump and an outlet coupled to an intermittent discharging mechanism. The latter comprises a first and a second valve for opening and closing the circulation line. The first valve is arranged directly stream downward of the outlet and the second valve is arranged stream downward with respect to the first one. The intermittent discharging mechanism further comprises a sucking pump that is communicatively coupled to a portion of the circulation line between the first and the second valve.

In operation the slot-die coating apparatus has a first operational mode, wherein the first valve is closed as a result of which the coating fluid flows to the outflow opening of the coating head for deposition on the substrate. The slot-die coating apparatus has a second operational mode, wherein the first valve is open and the second valve is closed, while the suction pump pumps coating liquid out of the manifold. As a result a flow of coating fluid from the outflow opening is interrupted. When the apparatus returns to its first operational mode, with the first valve in its closed state and the second valve in an opened state, the suction pump discharges the liquid pumped during the second mode back into the reservoir via the open second valve.

Unfortunately, it is found that an intermittent switching of the supply and/or removal and reapplication of the coating head may result in edge effects wherein the coating is no longer uniform e.g. due to the accumulation of coating material on the coating head. This applies in particular to coating liquids having a relatively low viscosity, e.g. in the range of 1 to 10 mPa·s. Typically, when slot-the coating such low-viscosity liquid a substantial amount thereof may be present between the outflow opening of the coating head and the surface of the substrate to be coated. For example an amount of coating liquid may be present on the outflow opening at a thickness that substantially exceeds a thickness with which the coating liquid is deposited on the substrate.

### SUMMARY OF THE INVENTION

It is an object of the invention to provide a slot-die coating apparatus and a slot-die coating method that enable a more uniform thickness of the coated layer near its edges.

In accordance therewith a coating apparatus is provided for manufacturing a patterned coating layer on a substrate surface of a substrate. The apparatus comprises a slot-die coating head, a coating fluid supply system, a controller for controlling the coating fluid supply system, and a substrate carrier for carrying the substrate. The slot-die coating head comprises an inlet for receiving coating fluid from the coating fluid supply system and a slit-shaped outflow opening communicatively coupled to the inlet and having a slit direction. In use the controller alternately causes the coating fluid supply system to operate in a first mode to provide for a flow of coating fluid out of the slit-shaped outflow opening for deposition on the substrate surface and in a second mode wherein a deposition of coating fluid onto the substrate surface is interrupted. The coating head has an internal coating fluid trajectory extending from the inlet to the slit-shaped outflow opening. In a stream-downwards order the coating fluid trajectory comprises a lateral distribution portion to distribute a flow of fluid over the slit direction, a collection channel extending transverse to the stream-downwards direction, and a flow resistive output portion. Upon a transition from the first mode to the second mode the controller causes the coating fluid supply system to suck coating fluid from the at least one outlet of the slot-die coating head that is communicatively coupled to the collection channel. In this transitional stage the combination of the above-mentioned subsequent elements in the internal coating fluid trajectory provide for a controlled and homogeneously distributed reflow of coating fluid into the slot-die coating head, therewith causing excess coating fluid outside the slit-shaped outflow opening (22) to flow via the flow resistive output portion, via the collection channel (24) to said at least one outlet. The controller for controlling the coating fluid supply system may be provided in any of various implementations, for example as dedicated hardware, as a suitably programmed general purpose processor or as a combination of dedicated and programmable elements. The controller may additionally be configured to control other units of the apparatus, for example a position of the coating head, a substrate transport velocity, and quality maintenance.

According to another aspect a slot-die coating method is provided for manufacturing a patterned coating layer on a substrate surface of a substrate using a slot-die coating head and a substrate carrier for carrying the substrate. The method comprises alternately operating in a first mode and a second mode. In the first mode coating fluid is supplied to the inlet of the coating head and laterally distributed in the lateral distribution portion. Subsequently the coating fluid flows via the flow resistive output portion to the outflow opening for deposition on the substrate. In the second mode M2 a deposition of coating fluid is interrupted. In particular in a transitional phase of the second mode M2 following the first mode a suction is applied to the at least one outlet. This causes excess coating fluid outside the slit-shaped outflow opening to flow in a laterally homogenously distributed manner via the flow resistive output portion, via the collection channel to the at least one outlet.

In embodiments the flow resistive output portion may have a flow resistance that is in a range between 0.05 times and 1 times a flow resistance of the lateral distribution portion, preferably in a range of 0.15 to 0.45.

### BRIEF DESCRIPTION OF THE DRAWINGS

These and other aspects are described in more detail with reference to the drawing. Therein:

FIG. 1 schematically shows a slot-die coating apparatus,

FIG. 1A further shows a cross-section according to IA-IA in FIG. 1,

FIG. 1B shows an aspect of an alternative embodiment of the slot-die coating apparatus of FIG. 1,

FIG. 2A-2C illustrate aspects of an intermittent operation of the apparatus of FIG. 1,

FIG. 3A-3C show representative states of the coating head in the first mode, in a transition from the first to the second mode and in the second mode respectively,

FIG. 4 shows an embodiment of the slot-die coating apparatus with coating fluid supply system in more detail,

FIG. 5 shows another embodiment of the slot-die coating apparatus with a coating fluid supply system in more detail,

FIG. 6 shows in more detail an example of a suction pump for use in a coating fluid supply system,

FIG. 7 shows an alternative embodiment of the a slot-the coating apparatus,

FIG. 8 illustrates an operation of the apparatus of FIG. 7,

FIG. 9 illustrates a detail of an embodiment of the slot-die coating apparatus,

FIG. 10A-10C illustrate a further embodiment of the slot-die coating apparatus,

FIG. 11 illustrates a still further embodiment of the slot-die coating apparatus.

### DETAILED DESCRIPTION OF EMBODIMENTS

Like reference symbols in the various drawings indicate like elements unless otherwise indicated.

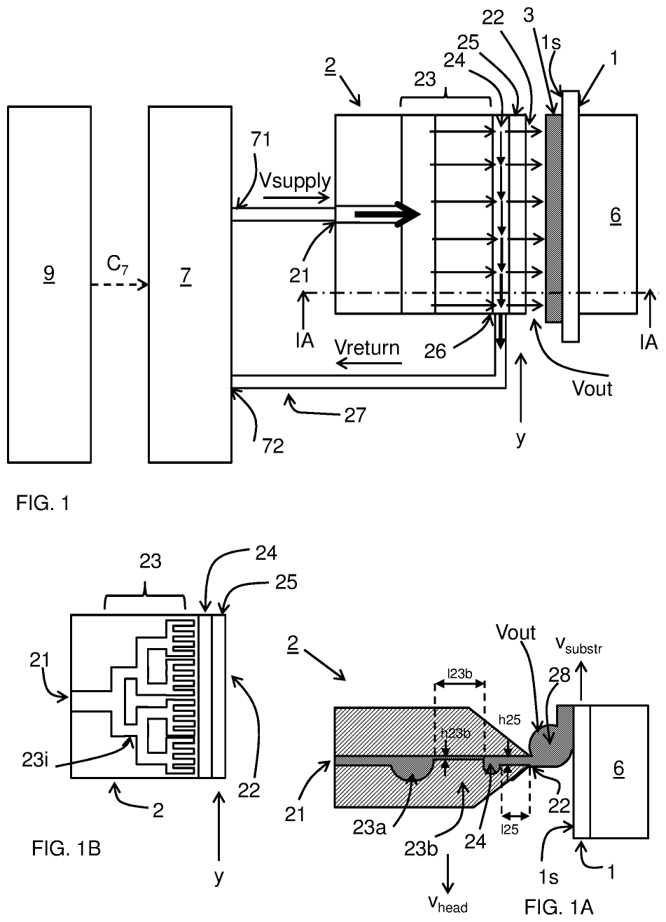

FIG. 1 schematically shows a slot-the coating apparatus for manufacturing a patterned coating layer 3 on a substrate surface 1s of a substrate 1. FIG. 1A further shows a cross-section according to IA-IA in FIG. 1.

The apparatus comprises a slot-the coating head 2, a coating fluid supply system 7, a controller 9 for controlling the coating fluid supply system, and a substrate carrier 6 for carrying the substrate 1. In an embodiment the substrate carrier 6 may provide for a fixed support of the substrate, and the coating head may be displaced at a velocity v_{head} as indicated in FIG. 1A. In an other embodiment the substrate carrier 6 may move the substrate 1 continuously or in discrete steps for example with a velocity v_{substr} as indicated in FIG. 1A. In other embodiments both the coating head 2 and the substrate 1 may be moved, for example in mutually orthogonal directions. For example the substrate carrier may provide for a continuous movement of the substrate 1 with a direction as indicated in FIG. 1A, and the coating head may be displaced in discrete steps in the direction y indicated in FIG. 1, each time the substrate has been moved over its full length in front of the coating head in the direction corresponding to v_{subst} in FIG. 1A. The substrate carrier 6 may for example have a flat surface carrying the substrate that is moved linearly but may alternatively provide for a rotating movement that provides for the translation of the substrate in front of the coating head 2.

The slot-die coating head 2 comprises an inlet 21 for receiving coating fluid from the coating fluid supply system 7 and a slit-shaped outflow opening 22 that is communicatively coupled to the inlet and that has a slit direction y. In use the controller 9 applies control signal C₇that alternately causes the coating fluid supply system 7 to operate in a first mode M1 and a second mode M2. In the first mode M1 it provides for a flow Vout of coating fluid out of the slit-shaped outflow opening 22 for deposition on the substrate surface 1s. In the second mode M2 a flow of coating fluid out of the slit-shaped outflow opening 22 is interrupted 21. The coating head 2 has an internal coating fluid trajectory extending from the inlet 21 to the slit-shaped outflow opening 22. The coating fluid trajectory comprises in a stream-downwards order a lateral distribution portion 23, a collection channel 24 and a flow resistive output portion 25.

In operation, the lateral distribution portion 23 distribute a flow of fluid over the slit direction y. In the embodiment shown the lateral distribution portion 23 comprises a comprises a lateral distribution channel 23a and a distribution gap 23b having a relatively high flow resistance in comparison to a flow resistance of the lateral distribution channel 23a.

The flow resistance R, in Pa·s·m⁻³, of a trajectory portion may be approximated by the following approximation based on the Poisseuille equation:

$$R = \frac{12 * η * Lst}{{h}^{3} * W}$$

Therein η is the dynamic viscosity of the fluid in Pa·s, Lₛₜ is the length of the trajectory in the flow direction in m, and W and h are the width the height of the trajectory portion in m.

In the embodiment shown the distribution gap 23b has a length l_{23b} and a height h_{23b}. The flow resistance of the distribution gap is substantially proportional to a ratio length l_{23b}/h_{23b}. By way of example the distribution gap may have a height h_{23b} of 25 to 500 micron and a length l_{23b} of 10 to 50 mm, wherein the ratio is in the range of 50 to 500. If this ratio is substantially less than 50, e.g. less than 10 than the flow may be insufficiently distributed in the lateral direction, and the ratio is substantially higher than 500, e.g. higher than 1000 than an unnecessary high load of the supply may result, at a relatively modest additional improvement of the lateral distribution.

FIG. 1B shows an alternative embodiment, according to the same view as FIG. 1, wherein the lateral distribution portion 23 is provided as a tree-like structure of distribution branches 23i.

Stream downwards of the lateral distribution portion 23, a collection channel 24 is provided that extends in a direction transverse to the stream-downwards direction. The collection channel 24 is communicatively coupled to one or more outlets. In the embodiment shown in FIG. 1 a single outlet 26 is provided that on its turn is communicatively coupled via suction channel 27 to an inlet 72 of the coating fluid supply system 7. The collection channel 24 is further communicatively coupled via the flow resistive output portion 25 with the slit-shaped outflow opening 22. The flow resistive output portion 25 has a flow resistance that is in a range between 0.05 times and 1 times a flow resistance of the lateral distribution portion 23. The relatively low flow resistance of the flow resistive output portion in comparison to the flow resistance of the lateral distribution portion enables an efficient suction of excess coating fluid from the slit-shaped outflow opening, whereas flow resistance of the flow resistive output portion has a value high enough to provide for a uniform distribution over the length direction of the slit.

The controller 9 is configured to cause the coating fluid supply system 7 to suck coating fluid from the outlet 26 of the slot-die coating head 2 upon a transition from the first mode M1 to the second mode M2. This suction of coating fluid may proceed during the second mode M2, to compensate for the supply of coating fluid from outlet 71 of the coating fluid supply system 7. Alternatively, this suction may be performed during a suction time interval shorter than the duration of the second mode M2 such that during the suction time interval an excess amount of fluid is sucked from the outflow opening 22 and possibly a portion of the flow resistive output portion 25, while during the remainder of the second mode the supply V_{supply} of coating fluid provides for a renewed formation of a bead of coating fluid at the outflow opening 22, possibly preceded by a refilling of the flow resistive output portion 25.

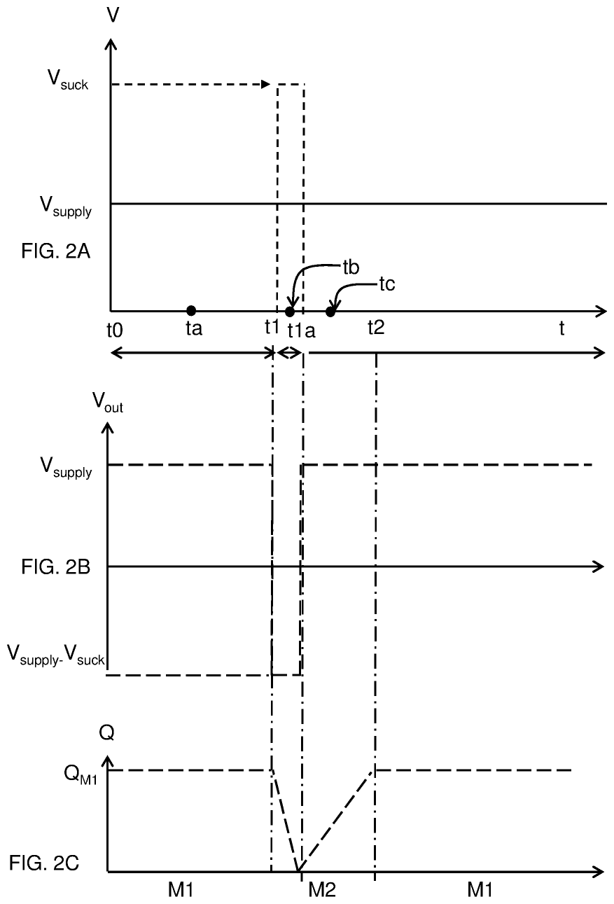

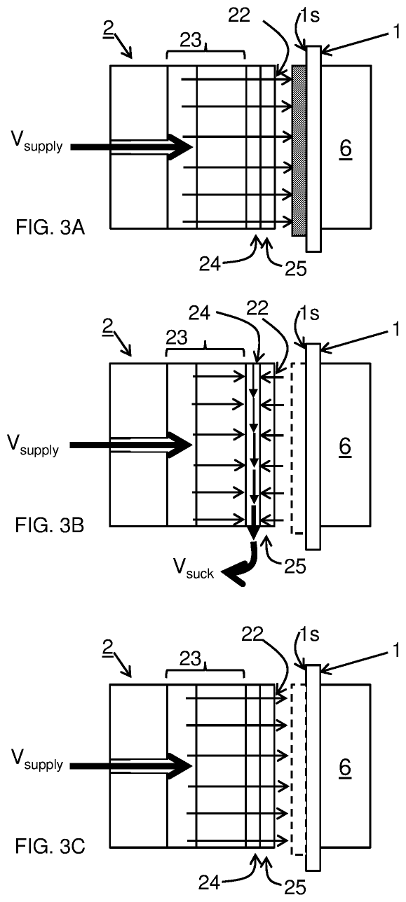

By way of example, FIG. 2A, 2B, 2C show a sequence of operational states M1, M2, M1. Therein FIG. 2A schematically shows the supplied flow of coating fluid (solid line) and the sucked flow of fluid (dashed line). FIG. 2B shows the outflow of coating fluid, and FIG. 2C, shows a quantity Q of coating fluid in a bead of coating fluid formed at the output slit 22. In the embodiment shown the coating fluid supply system 7 provides for a constant flow V_{supply} of coating fluid to the inlet 21 of the coating head 2. In a time-interval t0 to t1, the coating fluid supply system 7 operates in the first mode M1 wherein it provides for a flow Vout of coating fluid out of the slit-shaped outflow opening 22 equal to V_{supply}. A state of the coating head 2 in this first mode M1, for example at a point in time to is illustrated in FIG. 3A. In this time-interval a substantially constant amount Q_{M1} of coating fluid is present in the bead, as a stationary state prevails, wherein the flow of supplied coating fluid equals the amount of coated coating fluid that is carried away at the surface 1s of the substrate.

In a typical example a distance between the coating head and the substrate may be in a range of 25500 μm, a viscosity of the coating fluid 1-100 mPa·s, a nozzle cross-section diameter 25-350 μm, a relative speed between the coating head and substrate 3-30 metres per minute, a wet coating layer thickness 5-100 μm, e.g. 10 to 50 μm. Coating parameters may be determined e.g. experimentally and/or by model calculations.

As shown in FIG. 2A the coating fluid supply system 7 operates in a second mode M2 during a time interval ti to t2. Upon a transition of the first mode M1 to the second mode M2 the coating fluid supply system 7 sucks coating fluid from the outlet 26 of the slot-die coating head 2 at a flow rate V_{suck} during a time-interval t1-t1a. The state of the coating head 2 during this transition is illustrated in FIG. 3B. In the example shown, the flow rate V_{suck} exceeds the V_{supply} as a result of which the flow Vout assumes a negative value V_{supply}-V_{suck} during the time interval t1-t1a. Therewith the amount of coating fluid Q is reduced from Q_{M1} to 0 in this example, whereas during the remainder t1a to t2, the amount Q increases again to Q_{M1}, enabling further operation in the first mode M1 at point in time t2. In particular, as the flow resistive output portion 25 has a flow resistance that is in a range between 0.05 times and 1 times a flow resistance of the lateral distribution portion 23 it is achieved that the inward flow of coating fluid is evenly distributed over the length of the slit 22. Therewith a uniform boundary is obtained in the coating deposited in the preceding first mode. If the flow resistance of the flow resistive output portion 25 would be substantially lower than 0.05 times the flow resistance of the lateral distribution portion 23, e.g. 0.01 times smaller, then an uneven distribution of the inward flow could easily result due to a strong pressure gradient in the collection channel 24 in a direction away from the outlet 26 (see FIG. 1) where the coating fluid is sucked. As a result close to the outlet coating fluid would be sucked inward at a rate substantially higher than at positions more distant from the outlet. If the flow resistance of the flow resistive output portion 25 would be substantially greater than 1 times the flow resistance of the lateral distribution portion 23, e.g. greater than the flow resistance of the lateral distribution portion 23, a suction of the coating fluid would less effective, as it would be compensated by an increased inflow from the inlet, for example due to the fact that the coating fluid is to a certain extent compressible as a result of gas contained therein. Also flow variations may occur due to a pressure dependent operation of the supply pump, as most pumps tend to deliver an increased flow if a pressure reduction occurs at their output. As a further consequence it may be the case that the activation/deactivation of the suction mechanism causes pressure fluctuations at the input 21 of the coating head, as a result of which the outflow Vₒᵤₜ fluctuates also during first mode operation.

Whereas in this example the amount Q decreases to 0, also embodiments are conceivable wherein the amount is reduced to a value between 0 and Q_{M1}. Also embodiments are conceivable wherein the amount Q is reduced to a negative value, implying that also the flow resistive output portion 25 is (partially) discharged.

As indicated above, during the remainder t1a to t2, for example as illustrated for a point in time tc in FIG. 3C, the amount Q increases again to Q_{M1}, enabling further operation in the first mode M1 at point in time t2.

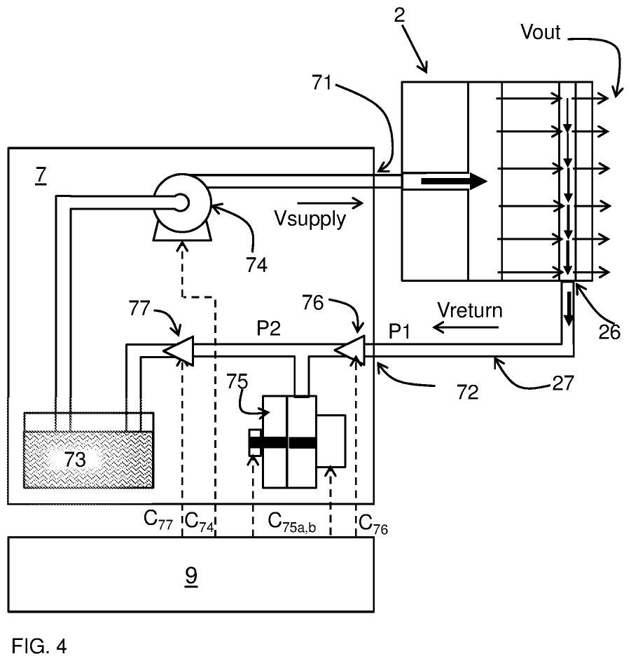

FIG. 4 shows in more detail an embodiment of the slot-die coating apparatus with the coating fluid supply system 7 in more detail. In the embodiment shown therein, the coating fluid supply system 7 comprises a controllable supply pump 74 that supplies the coating fluid from a reservoir 73. The controllable supply pump 74 is controllable by the controller 9 with a control signal C₇₄. The controller therewith may deactivate the controllable supply pump 74 if the second mode M2 should be maintained during a relatively long time interval t1-t2.

The coating fluid supply system 7 in this embodiment further comprises a suction pump 75 for sucking a discrete amount of coating fluid. Hence, upon each activation the suction pump 75, e.g. by control signal C₇₅ₐ, the suction pump 75 suck a preset quantity of coating fluid from the outlet 26. In the embodiment shown the suction pump 75 is provided to drain the discrete amount of fluid into the reservoir 73. To that end valves 76, 77 are provided that are controlled by the controller 9 with respective control signals C₇₆, C₇₇. In another embodiment the valves 76, 77 may operate autonomously. For example valve 76 may be arranged as a one-way valve that automatically opens if a pressure difference P1-P2 exceeds a threshold value. In this way it is prevented that during operation in mode M1 coating fluid flows away via return channel 27, whereas a flow of coating fluid is enabled in the transition from mode M1 to mode M2. The second valve can also be provided as a one-way valve, but its threshold can be arbitrary low.

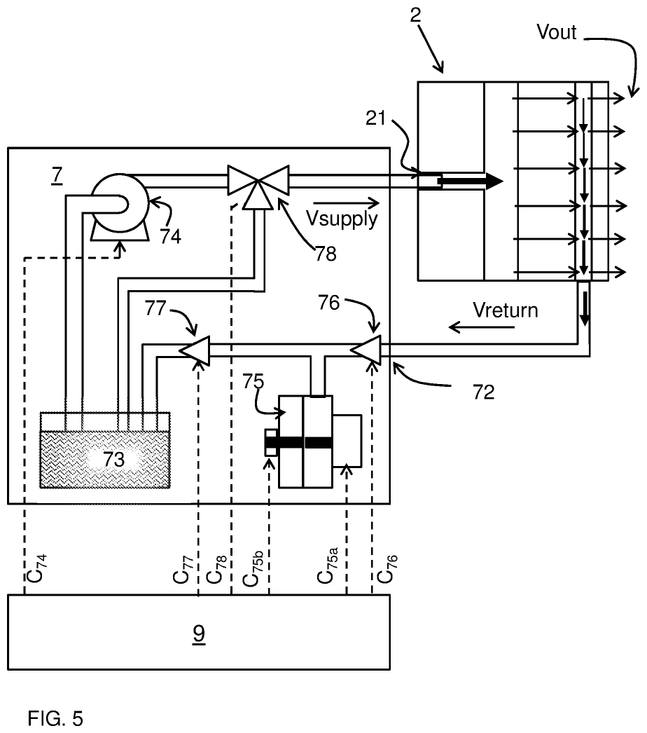

FIG. 5 shows an alternative embodiment wherein the coating fluid supply system 7 comprises a three-way valve 78. The three-way valve 78 is controllable by the controller 9 with a control signal C₇₈. During operation in mode M1, the controller 9 controls the valve 78 to direct the flow of coating fluid provided by the supply pump 74 to the inlet 21 of the coating head 2. In case a longer duration is desired of mode M2, the controller 9 may controls the valve 78 with signal C₇₈ to bypass the flow, in this example back to the reservoir 73. In the embodiment shown the controller 9 is configured to control both the supply pump 74 with a control signal C74 and to control the three-way valve 78 with a control signal C₇₈. If a still longer duration of the second mode is desired, the controller 9 may switch off the supply pump 74 and in case of medium durations the controller 9 may allow the three-way valve 78 to bypass the flow of coating fluid back to the reservoir 73. Also upon start up of the apparatus, the controller 9 may allow the three-way valve 78 to bypass the flow of coating fluid back to the reservoir 73 until the supply pump delivers the coating fluid at a stable flow rate.

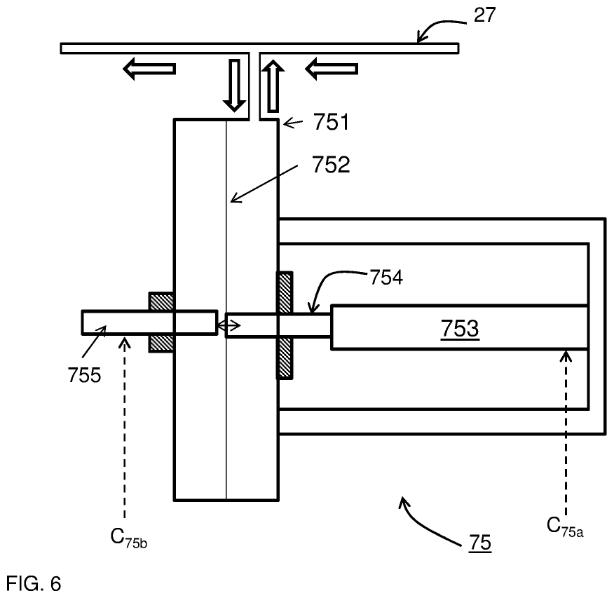

FIG. 6 shows an example of a suction pump 75 for use in a coating apparatus, for example the coating apparatus of FIG. 1, 4 or 5 as described above. In the embodiment shown the suction pump 75 is a membrane pump having a membrane 752 in a chamber 751 communicating with the suction channel 27. The membrane 752 is mechanically coupled by a bar 754 to an actuator 753 that is controlled by the controller 9 with control signal C₇₅ₐ. The actuator may be for example a piezo-actuator, an electromagnetic actuator or a pneumatic actuator. At an opposite side a stopper 755 is provided. In the embodiment shown the stopper 755 has a controllable position as determined by control signal C_{75b} from the controller 9. Alternatively, the stopper 755 may be manually positioned. Alternatively, or additionally a spring may be provided that counteracts a force exerted by the actuator, and may provide for a rapid returning of the membrane to a neutral position. In again another embodiment the membrane 752 may be stopped at a fixed position.

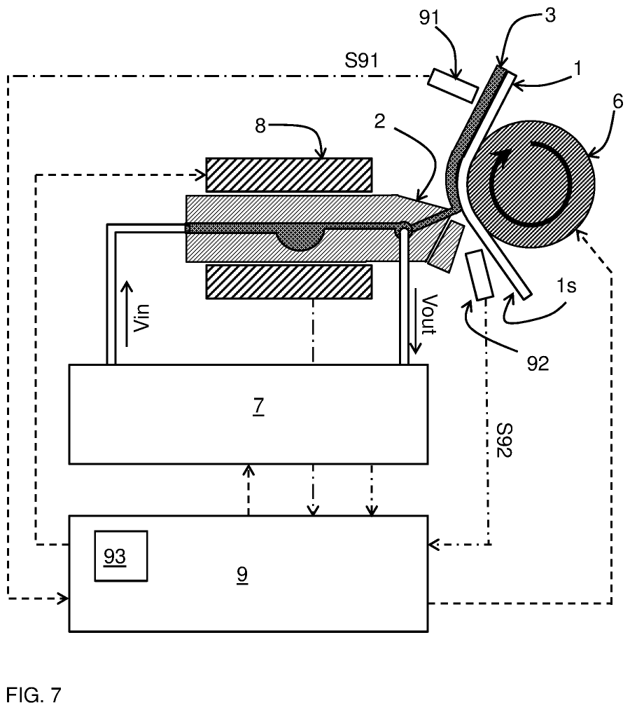

In an embodiment, for example the embodiment of FIG. 7, the controller 9 includes a control module 93 for controlling the dynamically controllable amount of fluid to be sucked by the a suction pump 75. The control module 93 may control the amount dependent on a detected boundary property of a boundary of the deposited layer. To this end the control module receive image data S91 from a camera system 91 that monitors the deposited layer 3. The detected boundary property of the boundary may for example be a thickness gradient in a transport direction of the substrate and/or a thickness gradient in the slit direction y.

In the embodiment shown the controller controls the position of the stopper 755 to automatically regulate an amount of sucked coating fluid.

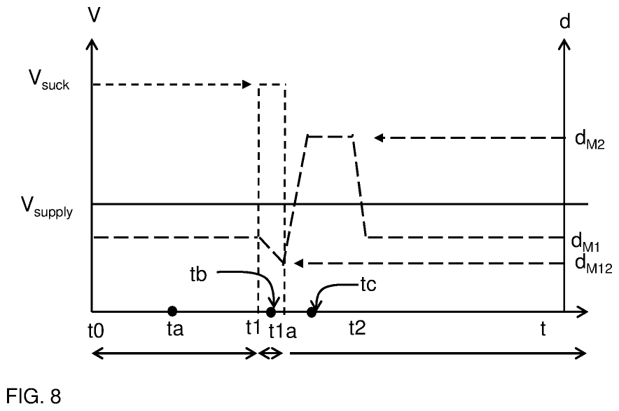

FIG. 7 shows an alternative embodiment of a coating apparatus of the invention. In the embodiment shown the apparatus comprises a positioning actuator 8 to dynamically position the slot-die coating head 2 with respect to the surface 1s of the substrate 1. The controller 9 is configured to control the positioning actuator 8 to position the coating head 2 with its outflow opening at a first distance with respect to the surface 1s of the substrate 1 during the first mode and at a second distance, larger than the first distance with respect to the surface 1s of the substrate 1 during the second mode. This is schematically illustrated in FIG. 8. In the first mode M1, a distance d between the outflow opening 22 and the surface 1s of the substrate is maintained at a distance d_{M1}, for example a distance of 100 micron. During the second mode M2 the distance is maintained at d_{M2}, having a value higher than d_{M1}. Therewith a better defined boundary can be obtained of deposited coating layer portions. It is not necessary that the distance of d_{M2} is maintained during the entire time interval spanned by the second mode M2. In particular, as shown in FIG. 8 during a transitionary phase of the second mode M2 following the first mode M1, the controller positions the coating head 2 with its outflow opening at a third distance d1ii2, smaller than the first distance d_{M1}, with respect to the surface 1s of the substrate. It is achieved therewith that an even more uniform suction of the coating fluid from the bead in front of the outflow opening 22 is achieved. In the embodiment shown it can be seen that the coating head 2 moves in the direction of the surface 1s in a transitionary period from t1 to t1a, subsequently moves to its remote position and at point in time t2 moves back to its position at the distance deli. In the embodiment shown the controller 9 receives feedback signals S92 from a distance monitor 92.

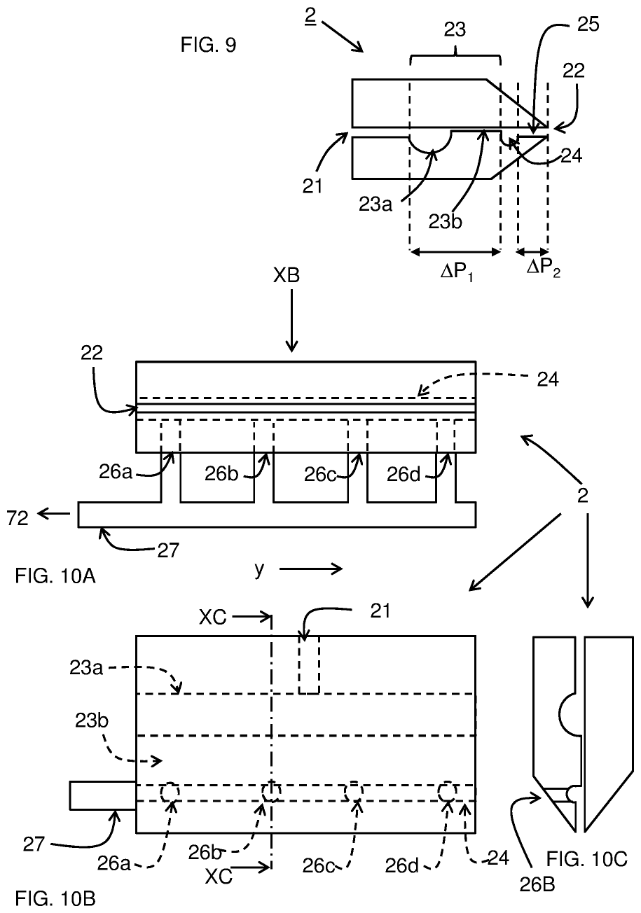

The ratio between the flow resistance in the lateral distribution portion 23 and in the flow resistive output portion 25 can also be expressed as a ratio of the pressure drops ΔP₁/ΔP₂ occurring in these portions during operation in the first mode. This is schematically indicated in FIG. 9.

Exemplary embodiments of the coating head as illustrated in FIG. 1A are presented in the following table. Therein the first and the second column respectively specify a height of the distribution gap 23b in micron, and a length of the distribution gap 23b in mm. The third and the fourth column respectively specify a height of the flow resistive output portion 25 in micron, and a length of the flow resistive output portion 25 in mm. The fifth and the sixth column respectively represent a pressure drop in Pa over the distribution gap 23b and over the flow resistive output portion 25 respectively. The last column specifies the ratio of these pressure drops. In this embodiment, the flow rate is set at 10 ml/min and the viscosity of the coating fluid is 1 mPa·s.

| h_{23b}(μm) | l_{23b}(mm) | h₂₅(μm) | l₂₅(mm) | ΔP1(Pa) | ΔP2(Pa) | ΔP1/ΔP2 |
|---|---|---|---|---|---|---|
| 100 | 2.5 | 100 | 1 | 193 | 77 | 2.5 |
| 100 | 2.5 | 200 | 2.5 | 193 | 24 | 8.0 |
| 100 | 2.5 | 200 | 1 | 193 | 10 | 20.0 |
| 100 | 1 | 200 | 2.5 | 77 | 24 | 3.2 |
| 100 | 1 | 200 | 1 | 77 | 10 | 8.0 |
| 200 | 2.5 | 200 | 1 | 24 | 10 | 2.5 |

For comparison the pressure drop in remaining parts of the fluid supply system is substantially lower. For example the pressure drop in the supply line towards the inlet 21 is merely 4 mPa, i.e. its magnitude is at least three orders of magnitude lower than that in the portions 23b, 25 of the coating head 2. Similarly, the pressure drop in the distribution channel 23a and the collection channel 24 is substantially lower, e.g. at least two orders of magnitude lower than those in the portions 23a, 25 respectively.

FIG. 10A, 10B, 10C show an alternative embodiment. Therein FIG. 10B shows a top-view according to XB in FIG. 10A, with hidden elements illustrated by dashed lines. FIG. 10C shows a cross-section according to XC-XC in FIG. 10B. In the embodiment of FIG. 10A, 10B, a plurality of outlets 26a, 26b, 26c, 26d are provided that each are communicatively coupled to the collection channel 24 at mutually different positions along the slit direction y. At an opposite end the outlets 26a, 26b, 26c, 26d are communicatively coupled to the drain channel 27 coupled to the coating fluid supply system 7.

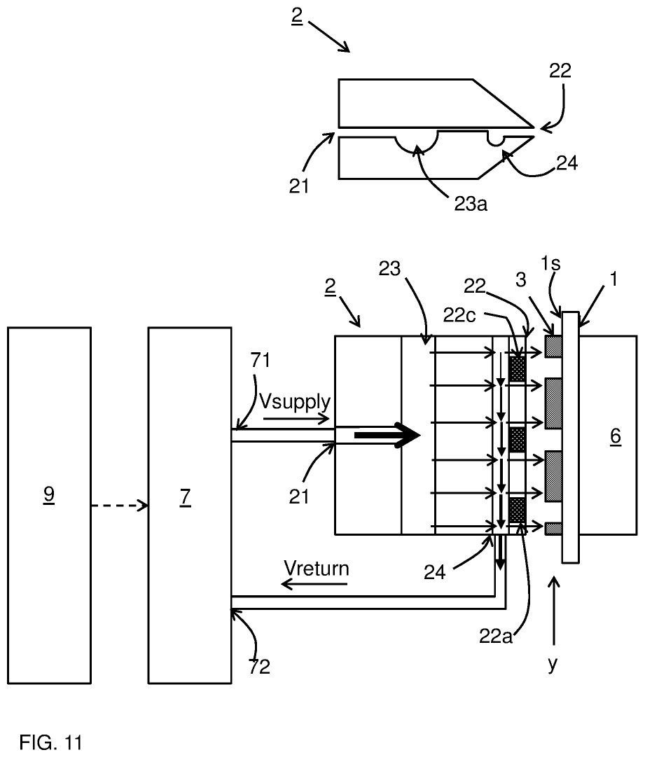

FIG. 11 shows an alternative embodiment. Therein the deposition slot 22 is provided with shims 22a, . . . , 22c to provide for a deposited layer 3 that is patterned in the slit direction.

While example embodiments were shown for providing a coating layer on a substrate, also alternative ways may be envisaged by those skilled in the art having the benefit of the present disclosure for achieving a similar function and result. The various elements of the embodiments as discussed and shown offer certain advantages, such as providing homogeneous coating layers. Of course, it is to be appreciated that any one of the above embodiments or processes may be combined with one or more other embodiments or processes to provide even further improvements in finding and matching designs and advantages, e.g. combinations of slot die coating, intermittent coating, shim coating, and/or pre-patterning a substrate. It is appreciated that this disclosure offers particular advantages to the manufacture of solar cell arrays, and in general can be applied for any application of large-scale production of homogeneous patterned layers on a substrate or web.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the scope of the present systems and methods as set forth in the claims that follow. The specification and drawings are accordingly to be regarded in an illustrative manner and are not intended to limit the scope of the appended claims.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. The mere fact that certain measures are recited in mutually different claims does not indicate that a combination of these measures cannot be used to advantage.

1. A slot-die coating apparatus for manufacturing a patterned coating layer on a substrate surface of a substrate, the apparatus comprising:
a slot-die coating head,
a coating fluid supply system,
a controller that controls the coating fluid supply system, and
a substrate carrier for carrying the substrate,
wherein the slot-die coating head comprises:
an inlet for receiving a coating fluid from the coating fluid supply system, and
a slit-shaped outflow opening communicatively coupled to the inlet and having a slit direction, and
wherein in use the controller alternately causes the coating fluid supply system to operate in:
a first mode to provide for a flow of coating fluid out of the slit-shaped outflow opening for deposition on the substrate surface, and
a second mode wherein a deposition of coating fluid out of the slit-shaped outflow opening on the substrate surface is interrupted,
wherein the slot-die coating head defines an internal coating fluid trajectory extending from the inlet to the slit-shaped outflow opening,
wherein the internal coating fluid trajectory, in a stream-downwards order, comprises:
a lateral distribution channel to distribute a flow of fluid over said slit direction,
a collection channel extending transverse to a stream-downwards direction, and
a flow resistive output portion,
wherein the internal coating trajectory includes a distribution gap stream from a distribution gap,
wherein the distribution gap stream is downstream from the lateral distribution channel and upstream of the collection channel,
wherein the distribution gap has a relatively high flow resistance in comparison to a flow resistance of the lateral distribution channel,
wherein the controller, upon a transition from the first mode to the second mode, causes the coating fluid supply system to suck coating fluid from at least one outlet of the slot-die coating head that is communicatively coupled to the collection channel, therewith causing excess coating fluid outside the slit-shaped outflow opening to flow via the flow resistive output portion, via the collection channel to said at least one outlet.

2. The slot-die coating apparatus of claim 1, wherein the coating fluid supply system comprises a suction pump for sucking a discrete amount of fluid.

3. The slot-die coating apparatus of claim 2, wherein the suction pump is provided to drain the discrete amount of fluid.

4. The slot-die coating apparatus according to claim 1, wherein the coating fluid supply system comprises a controllable supply pump.

5. The slot-die coating apparatus according to claim 1, wherein the coating fluid supply system comprises a three-way valve for controllably directing a flow of coating fluid provided by a supply pump either to the inlet of the slot-die coating head or bypassing said flow to the slot-die coating head.

6. The slot-die coating apparatus according to claim 3, wherein the suction pump is a membrane pump.

7. The slot-die coating apparatus according to claim 1, wherein the suction pump is configured to suck coating fluid from said outlet a flowrate exceeding the flowrate with which the coating fluid supply system supplies coating fluid to the inlet of the slot-die coating head during said first mode.

8. The slot-die coating apparatus according to claim 1, comprising a positioning actuator to dynamically position the slot-die coating head with respect to the surface of the substrate, and
wherein the controller is further provided to control the positioning actuator to position the slot-die coating head with its outflow opening:
at a first distance with respect to the surface of the substrate during said first mode, and
at a second distance, larger than the first distance., with respect to the surface of the substrate during said second mode.

9. The slot-die coating apparatus according to claim 8, wherein the controller is provided to position the slot-die coating head with its outflow opening at a third distance, smaller than said first distance, with respect to the surface of the substrate during a transition from the first mode to the second mode.

10. The slot-die coating apparatus according to claim 1, wherein the at least one outlet is one of a plurality of outlets that are communicatively coupled to the collection channel at mutually different positions along said slit direction,

11. The slot-die coating apparatus according to claim 1, wherein the outflow opening is provided with one or more shims that locally block a flow of coating fluid.

12. The slot-die coating apparatus according to claim 1, wherein the coating fluid supply system comprises a suction pump for sucking a dynamically controllable amount of fluid.

13. The slot-die coaling apparatus according to claim 12, wherein the controller includes a control module for controlling the dynamically controllable amount of fluid to be sucked by the a suction pump, dependent at least on a detected boundary property of a deposited layer.

14. A slot-die coating method for manufacturing a patterned coating layer on a substrate surface of a substrate, using a slot-die coating head and a substrate carrier for carrying the substrate, wherein:
the slot-die coating head comprises an inlet for receiving coating fluid and a slit-shaped outflow opening communicatively coupled to the inlet and having a slit direction,
the slot-die coating head defines an internal coating fluid trajectory extending from the inlet to the outflow opening,
the internal coating fluid trajectory in a stream-downwards order comprises:
a lateral distribution channel,
a collection channel extending transverse to the stream-downwards direction, and
a flow resistive output portion,
the slot-die coating head further comprising at least one outlet that is communicatively coupled to the collection channel,
the method comprises: alternately operating in a first mode and a second mode wherein:
in said first mode coating fluid is supplied to said inlet, said coating fluid is laterally distributed in the lateral distribution channel and flows via the collection channel and the flow resistive output portion to the outflow opening for deposition on the substrate, and
in said second mode a deposition of coating fluid onto the substrate surface is interrupted,
the internal coating fluid trajectory further includes a distribution gap stream from a distribution gap,
the distribution gap is downstream from the lateral distribution channel and upstream of the collection channel,
the distribution gap has a relatively high flow resistance in comparison to a flow resistance of the lateral distribution channel, and in that in said first mode of operation the coating fluid flows via the distribution gap from the lateral distribution channel to the collection channel and wherein upon a transition from the first mode to the second mode a suction is applied to the at least one outlet, causing excess coating fluid outside the slit-shaped outflow opening to flow via the flow resistive output portion, via the collection channel to said at least one outlet.

15. The slot-die coating apparatus according to claim 2 wherein the suction pump is configured to suck coating fluid from said outlet a flowrate exceeding the flowrate with which the coating fluid supply system supplies coating fluid to the inlet of the slot-die coating head during said first mode.

16. The slot-die coating apparatus according to claim 1 wherein the suction pump is configured to suck coating fluid from said outlet a flowrate exceeding the flowrate with which the coating fluid supply system supplies coating fluid to the inlet of the slot-die coating head during said first mode.

17. The slot-die coating apparatus according to claim 2, comprising a positioning actuator to dynamically position the slot-die coating head with respect to the surface of the substrate, and
wherein the controller is further provided to control the positioning actuator to position the slot-die coating head with its outflow opening:
at a first distance with respect to the surface of the substrate during said first mode, and
at a second distance, larger than the first distance, with respect to the surface of the substrate during said second mode.

18. The slot-die coating apparatus according to claim 3, comprising a positioning actuator to dynamically position the slot-die coating head with respect to the surface of the substrate, and
wherein the controller is further provided to control the positioning actuator to position the slot-die coating head with its outflow opening:
at a first distance with respect to the surface of the substrate during said first mode, and
at a second distance, larger than the first distance, with respect to the surface of the substrate during said second mode.

19. The slot-die coating apparatus according to claim 2, wherein the at least one outlet is one of a plurality of outlets that are communicatively coupled to the collection channel at mutually different positions along said slit direction.

20. The slot-die coating apparatus according to claim 3, wherein the at least one outlet is one of a plurality of outlets that are communicatively coupled to the collection channel at mutually different positions along said slit direction.
